(19) United States
(12) Patent Application Publication
(10) Pub. No.: US 2011/0098400 A1
(43) Pub. Date: Apr. 28, 2011

(54) Non-yellowing silicone composition

(76) Inventors: Delphine Blanc-Magnard, Lyon (FR); Georges Barrandon, Mornant (FR); Catherine George, Ecully (FR)

(21) Appl. No.: 11/794,088

(22) PCT Filed: Dec. 6, 2005
(86) PCT No.: PCT/FR05/03045

§ 371 Date: Aug. 4, 2008

(30) Foreign Application Priority Data
Dec. 23, 2004 (FR) 0413808

(51) Int. Cl. C08L 83/07; C08G 77/38

(52) U.S. Cl. 524/500; 525/477; 525/478; 524/588

(57) ABSTRACT

Polyorganosiloxane compositions crosslinkable by polyaddition reactions are provided. Methods for reducing yellowing of a silicone elastomer composition crosslinked by hydrosilylation including adding a polyorganosiloxane resin (D), comprising at least one Si-alkenyl unit, preferably Si-vinyl, to the silicone elastomer composition prior to crosslinking are also provided.

The field of the present invention is that of compositions based on polyorganosiloxanes capable of crosslinking by polyaddition or hydrosilylation reactions to form elastomers (RTV, LSR or gel) involving hydrogen substituents and ethylenically unsaturated radicals, that is to say alkenyls, in particular of the vinyl type. The hydrosilylation is generally catalyzed by metal compounds, for example of platinum nature.

The compositions based on polyorganosiloxanes considered according to the invention crosslink either at ambient temperature or with heat by polyaddition reactions in the presence of a metal catalyst.

The compositions according to the invention can be of RTV, LSR or gel type. By way of indication, the crosslinkable RTV silicone elastomer compositions have a viscosity η at 25° C. such that η≦200 000 mPa·s and the crosslinkable silicone LSR elastomer compositions have a viscosity η such that: 100 000≦η≦2 000 000 mPa·s.

Semisolid semiliquid silicone gels and which are conventionally used for the protection of electronic equipment sensitive to vibrations, to impacts or to temperature, and as base medical material, in particular for the preparation of prostheses, implants or dressings.

The expressions “RTV” and “LSR” are well known to a person skilled in the art: RTV is the abbreviation for “Room Temperature Vulcanizing” and LSR is the abbreviation for “Liquid Silicone Rubber”. These silicone elastomer compositions of the RTV, LSR or gel type are now well known and have formed the subject of various applications. Reference may be made, for example, to patent applications FR-A-2 775 481, FR-A-2 732 976 and FR-A-2 848 215.

However, one of the problems frequently encountered during the preparation of an elastomer from compositions of this type is the appearance of a more or less pronounced yellow coloring which is accentuated over time or by the use of an acceleration in the crosslinking by increasing the temperature.

This problem is even more significant for “transparent” silicone elastomers which are characterized by the absence or the presence at a very low level of siliceous reinforcing fillers.

Thus, one objective of the present invention is to develop a composition based on polyorganosiloxanes capable of crosslinking by polyaddition or hydrosilylation reactions to form elastomers (RTV, LSR or gel) not exhibiting the abovementioned disadvantages.

To achieve this objective, the inventors have received the credit for demonstrating, entirely surprisingly and unexpectedly, that the use of a specific alkenylated polyorganosiloxane resin, under carefully and judiciously chosen quantitative conditions, makes it possible to eliminate this problem of residual yellowing or at the very least to considerably reduce it.

This object is achieved by the present invention, which relates to the use, for reducing yellowing of a silicone elastomer composition crosslinked by hydrosilylation, of at least one polyorganosiloxane resin (D), comprising at least one Si-alkenyl unit, preferably Si-vinyl unit, which is added to said composition before crosslinking, said polyorganosiloxane resin (D) comprising:
a) at least one functionalized siloxyl unit of formula (I):

$$Y {R}_{a} {SiO}_{\frac{( 3 - a )}{2}} \qquad ( I )$$

in which Y is a C₂-C₁₂ alkenyl group, preferably a vinyl or allyl group, R is a monovalent hydrocarbon group chosen from alkyl groups having from 1 to 8 carbon atoms inclusive, such as the methyl, ethyl, propyl and 3,3,3-trifluoropropyl groups, and aryl groups, such as xylyl, tolyl and phenyl, and a=1 or 2,
b) at least one nonfunctionalized siloxyl unit of formula (II):

$${R}_{b} {SiO}_{\frac{( 4 - b )}{2}} \qquad ( II )$$

with R having the same definition as above and b=1, 2 or 3; and
c) at least one siloxyl unit Q of formula (III):

$${SiO}_{\frac{4}{2}} \qquad ( III )$$

it being possible for said polyorganosiloxane resin (D) optionally to comprise up to 2.5 mol % of silanol functional groups and preferably less than 0.5 mol % of silanol functional groups and it being possible for said silicone elastomer composition which is crosslinked by hydrosilylation optionally to comprise a reinforcing filler other than a polyorganosiloxane resin (D).

Faced with the problem posed by this residual yellowing of elastomers, it is to the credit of the inventors that they have understood the importance of the presence of a specific polyorganosiloxane resin (D) comprising Si-alkenyl units in silicone compositions crosslinking by polyaddition or hydrosilylation reactions.

This, inventive method makes it possible to eliminate this residual yellowing problem or at the very least to considerably reduce it.

The resins (D) of use according to the invention are silicone resins comprising “Si-alkenyl” functional groups, that is to say resins comprising vinyl, allyl and/or hexenyl functional groups.

According to a preferred form of the invention, the polyorganosiloxane resins (D) are vinylated silicone resins.

Advantageously, the vinylated silicone resins (D) according to the invention comprise, in their structures, from 0.1 to 20% by weight of alkenyl group(s).

In these resins, the alkenyl groups (Y) can be situated on siloxyl units (M), (D) or (T). A person skilled in the art in the field of silicones commonly uses this nomenclature which represents the following siloxyl units:
R₃SiO_{1/2} (M unit), RSiO_{3/2} (T unit) and R₂SiO_{2/2} (D unit).

These resins can be prepared, for example, according to the process described in U.S. Pat. No. 2,676,182.

The level of silanol groups in these resins can be controlled using a treatment well known to a person skilled in the art. This treatment involves a silazane, which makes it possible to lower the level of remaining silanol functional groups down to less than 0.3% by weight.

Some of these resins are available commercially, generally in the form of solutions.

In a preferred embodiment of the invention, the vinylated polyorganosiloxane resin (D) is a resin which comprises Si-Vi units and is chosen from the group consisting of the following silicone resins:
MD^{Vi}Q, where the vinyl groups are included in the (D) units,
MD^{Vi}TQ, where the vinyl groups are included in the (D) units,
MM^{Vi}Q, where the vinyl groups are included in a portion of the (M) units,
MM^{Vi}TQ, where the vinyl groups are included in a portion of the (M) units,
MM^{Vi}DD^{Vi}Q, where the vinyl groups are included in the (M) and (D) units,
and their mixtures,
   with:
M=siloxyl unit of formula R₃SiO_{1/2}
M^{Vi}=siloxyl unit of formula (R₂)(vinyl)SiO_{1/2}
D=siloxyl unit of formula R₂SiO_{2/2}
D^{Vi}=siloxyl unit of formula (R)(vinyl)SiO_{2/2}
Q=siloxyl unit of formula SiO_{4/2}
T=siloxyl unit of formula RSiO_{3/2}, and
the R groups, which are identical or different, are monovalent hydrocarbon groups chosen from alkyl groups having from 1 to 8 carbon atoms inclusive, such as the methyl, ethyl, propyl and 3,3,3-trifluoropropyl groups, and aryl groups, such as xylyl, tolyl and phenyl.

According to a particularly advantageous form, the polyorganosiloxane resin (D) is chosen from the group consisting of vinylated polyorganosiloxane resins of following formulae (IV) to (VI):

MM^{Vi}Q (IV),

MD^{Vi}Q (V) and

MM^{Vi}DD^{Vi}Q (VI)

with:
M=siloxyl unit of formula R₃SiO_{1/2}
M^{Vi}=siloxyl unit of formula (R₂)(vinyl)SiO_{1/2}
D=siloxyl unit of formula R₂SiO_{2/2}
D^{Vi}=siloxyl unit of formula (R)(vinyl)SiO_{2/2}
Q=siloxyl unit of formula SiO_{4/2}; and
the R groups, which are identical or different, are monovalent hydrocarbon groups chosen from alkyl groups having from 1 to 8 carbon atoms inclusive, such as the methyl, ethyl, propyl and 3,3,3-trifluoropropyl groups, and aryl groups, such as xylyl, tolyl and phenyl.

According to another specific form of the invention, the vinylated polyorganosiloxane resin (D) is added to the silicone elastomer composition crosslinked by hydrosilylation in the form of a mixture in at least one polyorganosiloxane oil.

According to another embodiment of the invention, the vinylated polyorganosiloxane resin (D) is present in the silicone elastomer composition before crosslinking at up to 20%, preferably up to 15% and more preferably still between 1 and 15%, by weight, with respect to the total weight of the composition.

According to a specific embodiment of the invention, the silicone elastomer composition crosslinked by hydrosilylation comprises, before crosslinking:
at least one polyorganosiloxane (A) exhibiting, per molecule, at least two alkenyl groups bonded to silicon;
at least one polyorganosiloxane (B) exhibiting, per molecule, at least three hydrogen atoms bonded to silicon;
a catalytically effective amount of at least one metal catalyst (C) (preferably based on platinum);
at least one vinylated polyorganosiloxane resin (D) as defined in claim 1 or 2,
optionally at least one crosslinking inhibitor (E);
optionally at least one adhesion promoter (F);
optionally a polyorganosiloxane (H) unreactive by polyaddition and
optionally a reinforcing or nonreinforcing filler (G); other than a vinylated polyorganosiloxane resin (D).

The polyorganosiloxanes (A) and (B) can advantageously be chosen from the following entities:
a polyorganosiloxane (A) comprising siloxyl units (VII) and (VIII):

R²ₙSiO_{(4-n/2)} (VII)

YR²_{y}SiO_{(3-y/2)} (VIII) and
a polyorganosiloxane (B) comprising siloxyl units (IX) and (X)

R²ₙSiO_{(4-n/2)} (IX)

HR²_{w}SiO_{(3-w/2)} (X)

in which formulae the various symbols have the following meanings:
the symbols R², which are identical or different, each represent a nonhydrolyzable group of hydrocarbon nature, it being possible for this radical to be:
a) an alkyl radical having from 1 to 5 carbon atoms and which can comprise from 1 to 6 chlorine atoms,
b) a cycloalkyl radical having from 3 to 8 carbon atoms and which can comprise from 1 to 4 chlorine atoms,
c) an aryl or alkylaryl radical having from 6 to 8 carbon atoms and which can comprise from 1 to 4 chlorine atoms, or
d) a cyanoalkyl radical having from 3 to 4 carbon atoms;
   the groups:
methyl, ethyl, propyl, isopropyl, butyl, isobutyl, n-pentyl, t-butyl, chloromethyl, dichloromethyl, ∝-chloroethyl, ∝,β-dichloroethyl, β-cyanoethyl, γ-cyanopropyl, phenyl, p-chlorophenyl, m-chlorophenyl, 3,5-dichlorophenyl, trichlorophenyl, tetrachlorophenyl, o-, p- or m-tolyl and xylyl (2,3-dimethylphenyl and 3,4-dimethylphenyl being preferred), the methyl and phenyl groups being particularly preferred;
   with:
the symbols Y, which are identical or different, representing a C₂-C₆ alkenyl group (preferably a vinyl group);
n=an integer equal to 0, 1, 2 or 3;
y=an integer equal to 0, 1 or 2; and
w=an integer equal to 0, 1 or 2.

The nature of the polyorganosiloxane (A) and thus the ratio of the siloxyl units (VII) to the siloxyl units (VIII) and the distribution of the latter are, as is known, chosen according to the crosslinking treatment which will be carried out on the curable composition for the purpose of converting it to an elastomer.

Mention may be made, as examples of siloxyl units of formula (VIII) constituting the polyorganosiloxane (A), of the following units: vinyldimethylsiloxyl, vinylphenylmethylsiloxyl, vinylmethylsiloxyl and vinylsiloxyl.

The dimethylsiloxyl, methylphenylsiloxyl, diphenylsiloxyl, methylsiloxyl and phenylsiloxyl units are examples of siloxyl units of formula (VII) of the polyorganosiloxane (A).

Examples of polyorganosiloxane (A) are linear and cyclic compounds, such as:
dimethylpolysiloxanes comprising dimethylvinylsilyl ends,
(methylvinyl)(dimethyl)polysiloxane copolymers comprising trimethylsilyl ends,
(methylvinyl)(dimethyl)polysiloxane copolymers comprising dimethylvinylsilyl ends, or
cyclic methylvinylpolysiloxanes.

As regards the polyorganohydrosiloxane (B), it is advantageously chosen from linear, cyclic or network homopolymers or copolymers exhibiting, on average, per molecule, preferably at least 3 hydrogen atoms bonded to different silicon atoms, the organic radicals of which bonded to silicon atoms are chosen from the methyl or ethyl radicals; 60 mol % at least of these radicals (and preferably all of these radicals) being methyl radicals.

According to an advantageous arrangement, the polyorganohydrosiloxane (B) is used in an amount such that the molar ratio of the hydride functional groups of the polyorganohydrosiloxane (B) to the vinyl groups of the polyorganosiloxane (A) is between 0.4 and 10.

Examples of siloxyl units composing the polyorganosiloxane (B) are the following: H(CH₃)₂SiO_{1/2}, H(CH₃) SiO_{2/2} or H(C₆H₅) SiO_{2/2}.

Mention may be made, as examples of polyorganosiloxane (B), of:
dimethylpolysiloxanes comprising hydrodimethylsilyl ends,
copolymers comprising (dimethyl)(hydromethyl)polysiloxane units comprising trimethylsilyl ends,
copolymers comprising (dimethyl)(hydromethyl)polysiloxane units comprising hydrodimethylsilyl ends,
(hydromethyl)polysiloxanes comprising trimethylsilyl ends, and
cyclic (hydromethyl)polysiloxanes.

These polyorganosiloxanes (A) and (B) are, for example, respectively a polyorganovinylsiloxane and a polyorganohydrosiloxane. The organic substituents other than the hydrogen and vinyl reactive groups are, for example, methyls or cyclohexyls. The hydrogens and the vinyls are carried by siloxyl units in place of one of the R groups in the following formulae:
M=siloxyl unit of formula R₃SiO_{1/2}
D=siloxyl unit of formula R₂SiO_{2/2}
T=siloxyl unit of formula RSiO_{3/2}.

These hydrogenated or vinylated units M or D each respectively comprise one or more H or vinyl groups, preferably just one.

The number of ≡SiH or ≡SiVi units per molecule is preferably greater than or equal to 1. This can in particular represent from 0.01% to 50% (preferably 0.1 to 10%) of vinyl by weight for the polyorganosiloxane (A) and from 0.001% to 5% (preferably 0.05 to 2%) of hydrogen by weight for the polyorganosiloxane (B). Appropriate polyorganosiloxanes (B) are:
polymethylhydrosiloxanes comprising —Si(CH₃)₃ ends,
polydimethylsiloxanes comprising —Si(₃)₂H ends,
methylhydrodimethylsiloxane polymers comprising —Si(CH₃)₂H and/or —Si(CH₃)₃,
methylhydrocyclosiloxane polymers,
polyorganohydrosiloxane resins.

Generally, the polyorganosiloxanes (A) and (B) have an average molecular weight of between 1×10² and 1×10⁷ (g/mol).

The compositions according to the invention can be of RTV, LSR or gel type. By way of indication, the crosslinkable RTV silicone elastomer compositions have a viscosity η at 25° C. such that η≦200 000 mPa·s and the crosslinkable LSR silicone elastomer compositions have a viscosity η such that: 100 000≦η≦2 000 000 mPa·s.

As regards the polyaddition polyorganosiloxanes (A) employed in the compositions according to the invention, several categories thereof are distinguished which differ in their viscosity and which define silicone elastomer compositions of RTV or LSR type.

In the case of the RTV compositions which crosslink by polyaddition reactions, the polyorganosiloxane constituent(s) (A) are chosen from those carrying alkenylsilyl groups which advantageously exhibit a viscosity η at 25° C. within the following range: 100≦η≦200 000 mPa·s and preferably 500≦η≦100 000 mPa·s.

In the case of the LSR compositions which crosslink by polyaddition reactions, the polyorganosiloxane(s) (A) carrying alkenylsilyl groups have, for example, a viscosity η′at 25° C. within the range 10 000≦η′≦500 000 mPa·s.

In the case of the RTV or LSR polyorganosiloxane compositions, the polyorganosiloxane constituent(s) (B) carrying hydrosilyl groups generally has (have) a viscosity at 25° C. at most equal to 10 000 mPa·s and preferably between 5 and 1000 mPa·s.

All the viscosities with which the present account is concerned correspond to a dynamic viscosity quantity at 25° C. measured, in a way known per se, at a shear rate gradient representative of its use.

According to an alternative form, it can be envisaged for the composition according to the invention to comprise mixtures of polyorganosiloxanes which differ in their nature and/or in their viscosity.

The metal catalysts (C) advantageously used in the composition according to the invention comprise all the catalysts of use in the hydrosilylation of polyorganosiloxanes carrying ≡Si—H units and of polyorganosiloxanes carrying ≡Si-(alkenyl unsaturation) units. They can thus be platinum, rhodium, iridium, nickel, ruthenium and/or palladium compounds. They are more particularly iridium compounds or better still platinum compounds.

The platinum compound can be any complex of platinum and of an organic product, e.g. those described in U.S. Pat. No. 3,159,601, U.S. Pat. No. 3,159,602 and U.S. Pat. No. 3,220,972 and European patents EP-A-0 057 459, EP-A-0 188 978 and EP-A-0 109 530, or any complex of platinum and of vinylated organosiloxanes, e.g. those described in U.S. Pat. No. 3,419,593, U.S. Pat. No. 3,715,334, U.S. Pat. No. 3,377,432 and U.S. Pat. No. 3,814,730.

Mention may be made of chloroplatinic acid, a chloroplatinic acid modified by an alcohol or also a complex of chloroplatinic acid with an olefin, an aldehyde or a vinylsiloxane, inter alia. U.S. Pat. No. 2,823,218 describes a hydrosilylation catalyst of the chloroplatinic acid type and U.S. Pat. No. 3,419,593 relates to catalysts formed by complexes of chloroplatinic acid and of organosilicone of the vinylsiloxane type. Complexes of platinum and of hydrocarbons of use as hydrosilylation catalyst are disclosed by U.S. Pat. Nos. 3,159,601 and 3,159,602. U.S. Pat. No. 3,723,497 describes a platinum acetylacetonate and U.S. Pat. No. 3,220,972 has as subject matter catalysts based on platinum alkoxide.

The catalysts (C) more especially selected in accordance with the invention are platinum/unsaturated siloxane complexes, in particular platinum/vinylsiloxane complexes, especially those obtained by reaction between a platinum halide and an unsaturated organosilicon material, such as an unsaturated silane or an unsaturated siloxane, e.g. according to the teaching of U.S. Pat. No. 3,775,452, to which a person skilled in the art may refer. The invention preferably applies to the Karstedt solution or complex described above.

As regards the crosslinking inhibitor (E), when it is present according to the applications targeted, it is added to the composition in an amount such that it inhibits the action of the catalyst at ambient temperature, this inhibitory action ceasing during the crosslinking treatment at high temperature; this amount is generally of the order of 0.001 to 1 part by weight.

Mention may be made, among the inhibitors, of dialkyl dicarboxylates (U.S. Pat. Nos. 4,256,870 and 4,476,166); dialkyl acetylenedicarboxylates (U.S. Pat. No. 4,347,346); acetylenic alcohols (U.S. Pat. Nos. 3,989,866, 4,336,364 and 3,445,420), and the like.

In accordance with one arrangement of the invention, when the composition is used for molding, it does not comprise an adhesion promoter (F). For other applications requiring properties of adhesion of the elastomer after crosslinking, at least one adhesion promoter (F) can be added to the composition. It preferably comprises a mixture comprising:
a) at least one alkoxylated organosilane comprising, per molecule, at least one C₂-C₆ alkenyl group, for example vinyltrimethoxysilane (VTMS); and
b) at least one organosilicon compound comprising at least one epoxy radical, for example epoxyalkoxysilicon compounds and more preferably still epoxyalkoxymonosilanes, such as:
   3-glycidoxypropyltrimethoxysilane (GLYMO), or
   3,4-epoxycyclohexylethyltrimethoxysilane.

An advantageous combination for forming the adhesion promoter is the following: VTMS/GLYMO.

According to the applications targeted, the reinforcing, unreinforcing or semireinforcing filler (G), other than a vinylated polyorganosiloxane resin (D), can be present in the composition.

When it is a reinforcing filler, it can be chosen from inorganic materials, in particular siliceous materials. The reinforcing siliceous fillers are chosen from colloidal silicas, fumed silica powders, precipitated silica powders or their mixtures. These powders exhibit a mean particle size generally of less than 0.1 μm and a BET specific surface of greater than 50 m²/g, preferably of between 50 and 400 m²/g, in particular between 90 and 350 m²/g.

When a nonreinforcing or semireinforcing (bulking) filler is used, it is advantageously employed as supplement to the reinforcing filler. This nonreinforcing or semireinforcing filler can itself also be selected from the group of inorganic materials comprising, inter alia, semireinforcing siliceous fillers, such as diatomaceous earths or ground quartz. It can also be a nonsiliceous inorganic material.

Examples of nonsiliceous fillers which can be used, alone or as a mixture, are carbon black, titanium dioxide, magnesium oxide, aluminum oxide, hydrated alumina, expanded vermiculite, unexpanded vermiculite, calcium carbonate, zinc oxide, mica, talc, iron oxide, barium sulfate, calcium hydroxide, diatomaceous earths, ground quartz and ground zirconia. These nonsiliceous fillers have a particle size generally of between 0.001 and 300 μm and a BET surface of less than 100 m²/g.

In practice but without implied limitation, the fillers employed can be a mixture of quartz and silica.

The fillers can be pretreated with any appropriate product, e.g. with chlorosilanes, cyclosiloxanes or hexamethyldisilazane (HMDZ), or other organosilicon compounds commonly employed for this use, such as organochlorosilanes, diorganocyclopolysiloxanes, hexaorganodisiloxanes, hexaorganodisilazanes or diorganocyclopolysilazanes (French patents FR-A-1 126 884, FR-A-1 136 885 and FR-A-1 236 505, and British patent GB-A-1 024 234).

An in situ treatment of silica with HMDZ is described in detail in patent application WO-A-98/58997, which is incorporated in its entirety in the present account by reference.

These fillers can be present in a proportion:
of 5 to 30%, preferably of 15 to 25%, with respect to the total composition, for the reinforcing fillers,
of 5 to 40%, preferably of 10 to 30%, preferably of 2 to 10% and more preferably of more than 3 or 4%, by weight, with respect to the total composition, for semireinforcing or bulking fillers.

More generally, quantitatively, the compositions according to the invention refer to standard proportions in the technical field under consideration, it being known that the application targeted also has to be taken into account.

The silicone compositions of the invention can additionally comprise conventional functional additives φ. Mention may be made, as families of conventional functional additives φ, of:
neutralizing agents
thermal stability additives,
additives for increasing the consistency
oil or fire resistance additives (for example, metal oxides).

According to another embodiment, the silicone elastomer composition crosslinked by hydrosilylation is not transparent and comprises, before crosslinking,
at least one polyorganosiloxane (A) exhibiting, per molecule, at least two alkenylated groups bonded to silicon;
at least one polyorganosiloxane (B) exhibiting, per molecule, at least three hydrogen atoms bonded to silicon;
a catalytically effective amount of at least one metal catalyst (C) (preferably based on platinum);
at least one vinylated polyorganosiloxane resin (D) as defined in claim 1 or 2;
at least one reinforcing, nonreinforcing or semireinforcing filler (G), other than a vinylated polyorganosiloxane resin (D),
optionally a polyorganosiloxane (H) unreactive by polyaddition,
optionally at least one crosslinking inhibitor (E); and
optionally at least one adhesion promoter (F).

The components (A) to (H) have the same definitions as above.

As regards the applications, the silicone elastomer composition crosslinked by, hydrosilylation is intended for applications in the field of molding, in particular prototyping or for the molding of dental or paramedical material, or in the field of silicone gels, in particular for the protection of electronic equipment sensitive to vibrations, to impacts or to temperature (potting), and as base medical material, in particular for the preparation of prostheses, implants or dressings.

The present invention will be better understood in the light of the examples which follow.

### EXAMPLES

The yellowing index is measured on a Spectro-Sensor II colorimeter sold by Applied Color Systems Inc.

### Example 1

### Vinylated Polyorganosiloxane (POS) Fluids

α,ω-(dimethylvinyl)polydimethylsiloxane (1): polydimethylsiloxane blocked by (CH₃)₂ViSiO_{0.5} units having a viscosity of approximately 600 mPa·s
α,ω-(dimethylvinyl)polydimethylsiloxane (2): polydimethylsiloxane blocked by (CH₃)₂ViSiO_{0.5} units having a viscosity of approximately 1500 mPa·s
α,ω-(dimethylvinyl)polydimethylsiloxane (3): polydimethylsiloxane blocked by (CH₃)₂ViSiO_{0.5} units having a viscosity of approximately 10 000 mPa·s
α,ω-(dimethylvinyl)polydimethylsiloxane (4): polydimethylsiloxane blocked by (CH₃)₂ViSiO_{0.5} units having a viscosity of approximately 100 000 mPa·s
α,ω-(dimethylvinyl)polydimethylsiloxane (5): polydimethylsiloxane blocked by (CH₃)₂ViSiO_{0.5} units having a viscosity of approximately 165 000 mPa·s
Vinylated resin according to the invention: vinylated polyorganosiloxane resin (6) of formula MM^{Vi}Q in solution (40% by weight) in polydimethylsiloxane blocked by (CH₃)₂ViSiO_{0.5} units; the vinyl content of this composition is 1.1% by weight.
SiH crosslinking agent: SiH siloxane crosslinking agent (7) with the structure M′Q; the SiH content is 26% by weight.
Catalyst: Karstedt platinum catalyst.

TABLE 1
Yellowing index of silicone composition after crosslinking at ambient temperature for 24 h

| Nature of the | POS (1) | POS (2) | POS (3) | POS (4) | POS (5) | Vinylated |
|---|---|---|---|---|---|---|
| vinylated fluid/ | 600 | 1500 | 10 000 | 100 000 | 165 000 | resin (6) |
| viscosity (mPa · s) | Comparative | Comparative | Comparative | Comparative | Comparative | Invention |
| Amount of the | 90 | 90 | 90 | 90 | 90 | 92 |
| vinylated fluid | | | | | | |
| SiH crosslinking | 1.75 | 1.2 | 0.6 | 0.29 | 0.25 | 4.8 |
| agent (7) | | | | | | |
| Polydimethylsiloxane | 10 | 10 | 10 | 10 | 10 | 10 |
| with a viscosity of | | | | | | |
| 500 mPa · s | | | | | | |
| Pt catalyst (8), ppm | 40 | 40 | 40 | 40 | 40 | 40 |
| Yellow index after | 9.77 | 7.24 | 12.76 | 18.26 | 22.58 | 2.91 |
| 24 h | | | | | | |
| Yellow index after | 10.92 | 11.74 | 14.52 | 20.51 | 26.50 | 2.68 |
| 96 h | | | | | | |

The amounts in table 1 are given in parts (weight), except for the Pt catalyst, given in ppm of platinum.
SiH/SiVi ratio = 1.2.

It is noticed that the composition comprising a vinylated resin according to the invention (6) results in very low yellow indices compared with the other compositions comprising the POSs (1) to (5).

### Example 2

TABLE 2
Yellowing index of silicone composition after
crosslinking at ambient temperature for 24 h

| | Comparative | Invention |
|---|---|---|
| Vinylated resin (6) | 0 | 9 |
| Vinylated POS fluid (4) | 90 | 81 |
| SiH crosslinking agent (7) | 0.29 | 0.74 |
| Polydimethylsiloxane with a | 10 | 10 |
| viscosity of 500 mPa · s | | |
| Pt catalyst (8), ppm | 40 | 40 |
| Yellow index after 24 h | 18.26 | 4.73 |
| Yellow index after 96 h | 20.51 | 4.22 |

The amounts in table 2 are given in parts (weight), except for the Pt catalyst, given in ppm of platinum. SiH/SiVi ratio=1.2.

It is noticed that the addition of vinylated resin according to the invention (6) makes it possible to reduce the yellowing index by almost 75%.

### Example 3 (Comparative)-Example 4 (Invention)

### Preparation of the Two-Component Crosslinkable Silicone Composition RTV 2 (Comp.)

### Part A1 of the Two-Component Composition:

The following are mixed in a reactor at ambient temperature:
80 parts by weight of a polyorganosiloxane which is an α,ω-divinylpolydimethylsiloxane
20 parts by weight of silica treated with hexamethyldisilazane (HMDZ), and
20 ppm of platinum.

### Part B1 of the Two-Component Composition:

The following are mixed in a reactor at ambient temperature:
34 parts by weight of a polyorganosiloxane which is an α,ω-divinylpolydimethylsiloxane
14 parts by weight of silica treated with hexamethyldisilazane (HMDZ)
16 parts by weight of a polyorganosiloxane which is an α,ω-dihydropolydimethylsiloxane
34 parts by weight of a polyorganosiloxane which is an α,ω-dihydropoly(dimethyl)(methylhydro)siloxane
2 parts by weight of a tetra(vinylmethyl)cyclosiloxane.

The two-component RTV 2 (Comp.) is obtained by mixing 100 parts of A1 and 10 parts of B1 at ambient temperature.

Preparation of the Two-Component Crosslinkable Silicone Composition RTV 2 (Inv.)

### Part A2 of the Two-Component Composition:

The following are added to part A1 (100 g) of the composition described in example 3:
5 g of the vinylated polyorganosiloxane resin (6), and
0.26 g of SiH siloxane crosslinking agent (7).

The two-component composition RTV 2 (Inv.) is obtained by mixing 100 parts of A2 and 10 parts of B1 at ambient temperature.

TABLE 3
Yellowing index of silicone composition after
crosslinking at ambient temperature for 24 h

| | RTV-2 (Comp.) | RTV 2 (Inv.) |
|---|---|---|
| | Example 3 | Example 4 |
| Yellow index after 24 h | 15.67 | 12.39 |
| Yellow index after 96 h | 15.86 | 12.75 |

It is noticed that the addition of the vinylated resin (6) according to the invention makes it possible to reduce the yellowing index by almost 20%.

What is claimed is:

1. The use, for reducing yellowing of a silicone elastomer composition crosslinked by hydrosilylation, of at least one polyorganosiloxane resin (D), comprising at least one Si-alkenyl unit, preferably Si-vinyl unit, which is added to said composition before crosslinking, said polyorganosiloxane resin (D) comprising:
a) at least one functionalized siloxyl unit of formula (I):
$$Y {R}_{a} {SiO}_{\frac{( 3 - a )}{2}} \qquad ( I )$$
in which Y is a C₂-C₁₂ alkenyl group, preferably a vinyl or allyl group, R is a monovalent hydrocarbon group chosen from alkyl groups having from 1 to 8 carbon atoms inclusive, such as the methyl, ethyl, propyl and 3,3,3-trifluoropropyl groups, and aryl groups, such as xylyl, tolyl and phenyl, and a=0, 1 or 2,
b) at least one nonfunctionalized siloxyl unit of formula (II):
$${R}_{b} {SiO}_{\frac{( 4 - b )}{2}} \qquad ( II )$$
with R having the same definition as above and b=1, 2 or 3; and
c) at least one siloxyl unit Q of formula (III):
$${SiO}_{\frac{4}{2}} \qquad ( III )$$
it being possible for said polyorganosiloxane resin (D) optionally to comprise up to 2.5 mol % of silanol functional groups and preferably less than 0.5 mol % of silanol functional groups and it being possible for said silicone elastomer composition which is crosslinked by hydrosilylation optionally to comprise a reinforcing filler other than a polyorganosiloxane resin (D).

2. The use as claimed in claim 1, in which the vinylated polyorganosiloxane resin (D) is a resin which comprises Si-Vi units and which is chosen from the group consisting of:
MD^{Vi}Q, where the vinyl groups are included in the (D) units,
MD^{Vi}TQ, where the vinyl groups are included in the (D) units,
MM^{Vi}Q, where the vinyl groups are included in a portion of the (M) units,
MM^{Vi}TQ, where the vinyl groups are included in a portion of the (M) units,
MM^{Vi}DD^{Vi}Q, where the vinyl groups are included in the (M) and (D) units,
and their mixtures,
with:
M=siloxyl unit of formula R₃SiO_{1/2}
M^{Vi}=siloxyl unit of formula (R₂)(vinyl)SiO_{1/2}
D=siloxyl unit of formula R₂SiO_{2/2}
D^{Vi}=siloxyl unit of formula (R)(vinyl)SiO_{2/2}
Q=siloxyl unit of formula SiO_{4/2}
T=siloxyl unit of formula RSiO_{3/2}, and
the R groups, which are identical or different, are monovalent hydrocarbon groups chosen from alkyl groups having from 1 to 8 carbon atoms inclusive, such as the methyl, ethyl, propyl and 3,3,3-trifluoropropyl groups, and aryl groups, such as xylyl, tolyl and phenyl.

3. The use as claimed in either of the preceding claims, in which the polyorganosiloxane resin (D) is chosen from the group consisting of vinylated polyorganosiloxane resins of following formulae (IV) to (VI):
MM^{Vi}Q (IV),
MD^{Vi}Q (V) and
MM^{Vi}DD^{Vi}Q (VI)
with:
M=siloxyl unit of formula R₃SiO_{1/2}
M^{Vi}=siloxyl unit of formula (R₂)(vinyl)SiO_{1/2}
D=siloxyl unit of formula R₂SiO_{2/2}
D^{Vi}=siloxyl unit of formula (R)(vinyl)SiO_{2/2}
Q=siloxyl unit of formula SiO_{4/2}; and
the R groups, which are identical or different, are monovalent hydrocarbon groups chosen from alkyl groups having from 1 to 8 carbon atoms inclusive, such as the methyl, ethyl, propyl and 3,3,3-trifluoropropyl groups, and aryl groups, such as xylyl, tolyl and phenyl.

4. The use as claimed in one of the preceding claims, in which the silicone elastomer composition crosslinked by hydrosilylation comprises, before crosslinking:
at least one polyorganosiloxane (A) exhibiting, per molecule, at least two alkenyl groups bonded to silicon;
at least one polyorganosiloxane (B) exhibiting, per molecule, at least three hydrogen atoms bonded to silicon;
a catalytically effective amount of at least one metal catalyst (C) (preferably based on platinum);
at least one vinylated polyorganosiloxane resin (D) as defined in claim 1 or 2,
optionally at least one crosslinking inhibitor (E);
optionally at least one adhesion promoter (F);
optionally a polyorganosiloxane (H) unreactive by polyaddition and
optionally a reinforcing or nonreinforcing filler (G); other than a vinylated polyorganosiloxane resin (D).

5. The use as claimed in one of the preceding claims, in which the silicone elastomer composition crosslinked by hydrosilylation is not transparent and comprises, before crosslinking,
at least one polyorganosiloxane (A) exhibiting, per molecule, at least two alkenylated groups bonded to silicon;
at least one polyorganosiloxane (B) exhibiting, per molecule, at least three hydrogen atoms bonded to silicon;
a catalytically effective amount of at least one metal catalyst (C) (preferably based on platinum);
at least one vinylated polyorganosiloxane resin (D) as defined in claim 1 or 2;
at least one reinforcing, nonreinforcing or semireinforcing filler (G), other than a vinylated polyorganosiloxane resin (D),
optionally a polyorganosiloxane (H) unreactive by polyaddition,
optionally at least one crosslinking inhibitor (E); and
optionally at least one adhesion promoter (F).

6. The use as claimed in one of the preceding claims, in which the vinylated polyorganosiloxane resin (D) is present in the silicone elastomer composition before crosslinking at up to 20%, preferably up to 15% and more preferably still between 1 and 15%, by weight, with respect to the total weight of the composition.

7. The use as claimed in one of the preceding claims, in which the silicone elastomer composition crosslinked by hydrosilylation is intended for applications in the field of molding, in particular prototyping or for the molding of dental or paramedical material, or in the field of silicone gels, in particular for the protection of electronic equipment sensitive to vibrations, to impacts or to temperature, and as base medical material, in particular for the preparation of prostheses, implants or dressings.
